(19) United States
(12) Patent Application Publication
(10) Pub. No.: US 2017/0169599 A1
(43) Pub. Date: Jun. 15, 2017

(54) METHODS AND ELECTRONIC DEVICES FOR DISPLAYING PICTURE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Lei LIU, Beijing (CN)

(21) Appl. No.: 15/240,097

(22) Filed: Aug. 18, 2016

Related U.S. Application Data
(63) Continuation of application No. PCT/CN2016/089165, filed on Jul. 7, 2016.

(30) Foreign Application Priority Data
Dec. 15, 2015 (CN) 201510937804.9

(51) Int. Cl. G06T 13/80; G06T 3/40; G09G 5/34

(52) U.S. Cl. CPC G06T 13/80; G09G 5/34; G06T 3/40

(57) ABSTRACT

The present disclosure provides methods and electronic devices for displaying picture which may be applied to a terminal device, wherein the method includes: obtaining a picture to be displayed; obtaining an animation corresponding to the picture; and displaying the animation firstly and then displaying the picture when the picture is to be displayed. In embodiments of the present disclosure, when a picture in a page is to be displayed, instead of being displayed immediately, an animation is displayed firstly, for example, an animation by having the picture shown with a gradient effect is displayed firstly, and then the picture itself is displayed. Although it may take a little additional time to obtain and display the animation, the picture can be shown naturally during a transition from being absent to being present, rather than being popped out abruptly, which allows the user to feel a fluent display in the page.

### CROSS REFERENCE TO RELATED APPLICATIONS

The present application is a continuation of international application No. PCT/CN2016/089165 filed on Jul. 7, 2016, and claims a priority of Chinese Patent Application No. 201510937804.9, entitled “METHOD AND DEVICE FOR DISPLAYING PICTURE”, filed with the State Intellectual Property Office of China on Dec. 15, 2015, both of which are incorporated herein by reference in its entireties.

### TECHNICAL FIELD

The present disclosure relates to the field of communication, and in particular, to methods and electronic devices for displaying picture.

### BACKGROUND

When a user browses a webpage on a terminal device such as mobile phone by a browser or APP (application software), if the webpage is too long to load all contents thereof on full screen, pictures outside the screen are generally loaded to be displayed on the screen in real time as the screen is scrolled.

When pictures are loaded to be displayed on a screen, the screen will be directly changed from having no picture to having picture, in other words, a whole picture is directly displayed. However, in a process of implementing the present disclosure, the inventor found that, if there are too many pictures in a page, even though the pictures to be displayed may have been downloaded from network to a terminal device, the pictures will be loaded slowly and such loading cannot be completed immediately because of limitations such as processing speed of hardware in the terminal device. For example, the user will see a blank box firstly, and then see a picture popped out therefrom, which may lead the user to feel not smooth in loading the pictures to the page, thus the user may misunderstand that the network speed is slow.

### SUMMARY

To overcome the technical problem existing in the prior art, the present disclosure provides methods and electronic devices for displaying picture, so as to achieve more fluent effect when pictures are loaded to be displayed in a page.

According to a first aspect of embodiments of the present disclosure, a method for displaying picture is provided, including: obtaining a picture to be displayed; obtaining an animation corresponding to the picture; and displaying the animation firstly and then displaying the picture, when the picture is to be displayed.

According to a second aspect of embodiments of the present disclosure, there provides a non-volatile computer readable storage medium stored with computer executable instructions, which are set to perform any one of the above methods for displaying picture.

According to a third aspect of embodiments of the present disclosure, there provides an electronic device including at least one processor and a memory, wherein the memory is stored with instructions executable by the one or more processors, and the instructions are set to perform any one of the above methods for displaying picture.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

To illustrate technical schemes in embodiments of the present disclosure or the prior art more clearly, figures used in the description of embodiments or the prior art are described briefly as follows. It is obvious that the figures in the description below are some embodiments of the present disclosure, and one of ordinary skilled in the art can obtain other figures according to those following figures without any creative work.

FIG. 1 is a flowchart illustrating a method for displaying picture according to an exemplary embodiment;

FIG. 2 is a schematic diagram illustrating user's gestures according to an exemplary embodiment;

FIG. 3 is a flowchart illustrating a method for displaying picture according to an exemplary embodiment;

FIG. 4 is a schematic diagram illustrating a state before a picture to be displayed is displayed according to an exemplary embodiment;

FIG. 5 is a schematic diagram illustrating a state when a picture to be displayed has been displayed according to an exemplary embodiment;

FIG. 6 is a schematic diagram illustrating a process of displaying a picture to be displayed according to an exemplary embodiment;

FIG. 7 is a flowchart illustrating a method for displaying picture according to an exemplary embodiment;

FIG. 8 is a schematic diagram illustrating a device for displaying picture according to an exemplary embodiment;

FIG. 9 is a schematic diagram illustrating a device for displaying picture according to an exemplary embodiment;

FIG. 10 is a schematic diagram illustrating a device for displaying picture according to an exemplary embodiment; and

FIG. 11 is a schematic structure diagram of an electronic device for a method for displaying picture according to an exemplary embodiment.

### DETAILED DESCRIPTION

Exemplary embodiments, of which examples are shown in the drawings, will be illustrated in detail herein. When the description below is related to the drawings, same reference numeral in different drawings represents same or similar element, unless otherwise expressed. The implementations described in the following exemplary embodiments do not represent all the implementations consistent with the invention. Instead, they are only examples of device and method consistent with some aspects of the invention as described in detail in the appended claims.

A terminal device herein may be a mobile phone, tablet computer, E-book reader, MP3 (Moving Picture Experts Group Audio Layer III) player, MP4 (Moving Picture Experts Group Audio Layer IV) player, laptop portable computer and the like.

FIG. 1 is a flowchart illustrating a method for displaying picture according to an exemplary embodiment. The method may be applied to a terminal device such as mobile phone, tablet computer and the like.

Referring to FIG. 1, the method may include the following steps.

In step S101, a picture to be displayed is obtained.

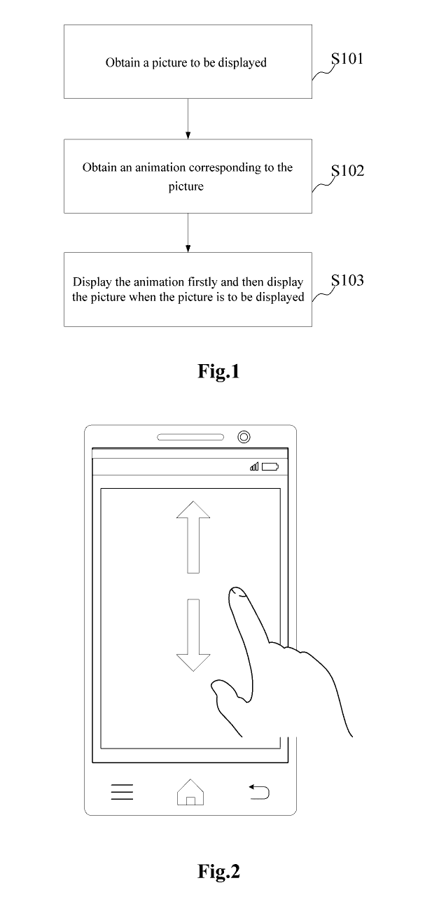

Taking mobile phone as an example, when a user browses a webpage on the mobile phone using a browser or APP (application software), if the webpage is too long to display all contents thereof on one screen, pictures outside the screen will generally be loaded to be displayed on the screen in real time as the screen is scrolled by the user. Referring to FIG. 2, as an example, the user may allow the contents displayed on the screen to be scrolled up and down by sliding fingers up and down on the screen of mobile phone, so as to browse a relatively long page.

To improve speed of displaying picture in real time when the page is browsed by being scrolled, mobile phone may download all pictures in the whole page in advance, or may predict user's browsing behavior to determine which pictures are to be displayed, and then download the pictures to the mobile phone in advance.

In step S102, an animation corresponding to the picture is obtained.

The animation is to be displayed in advance before the picture is displayed. As for how to obtain an animation corresponding to the picture, there is no limitation in the present embodiment.

In step S103, the animation is displayed firstly, and the picture is then displayed when the picture is to be displayed.

When pictures are loaded to be displayed on a screen, the screen will be directly changed from having no picture to having picture, in other words, a whole picture is directly displayed. While in reality, if there are too many pictures in a page, even though the pictures to be displayed may have been downloaded from network to a terminal device, the pictures will be loaded slowly and such loading cannot be completed immediately because of limitations such as processing speed of hardware in the terminal device. For example, the user will see a blank box firstly, and then see a picture popped out therefrom, which may lead the user to feel not smooth in loading the pictures to the page, thus the user may misunderstand that the network speed is slow.

However, in the present embodiment, when a picture in a page is to be displayed, instead of being displayed immediately, an animation is displayed firstly, and then the picture itself is displayed. Although it may take a little additional time to obtain and display the animation, the picture can be shown naturally during a transition from being absent to being present, rather than being popped out abruptly, which allows the user to feel a fluent display in the page, thereby improving user's experiences.

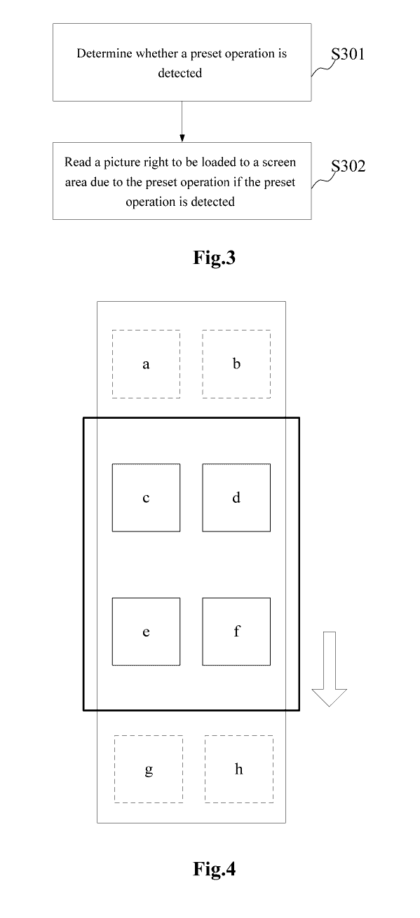

Referring to FIG. 3, in the present embodiment or some other embodiments of the present disclosure, the obtaining the picture to be displayed may include the following steps.

In step S301, whether a preset operation is detected is determined.

In step S302, a picture right to be loaded to a screen area due to the preset operation is read if the preset operation is detected.

For example, the preset operation may include a scrolling operation toward a preset direction, and the reading the picture right to be loaded to the screen area due to the preset operation may include reading the picture right to be loaded to the screen area in the scrolling direction.

If it is a scrolling operation toward a preset direction, it means that the picture right to enter the screen area in the direction is right to be displayed, and such picture is a picture to be displayed.

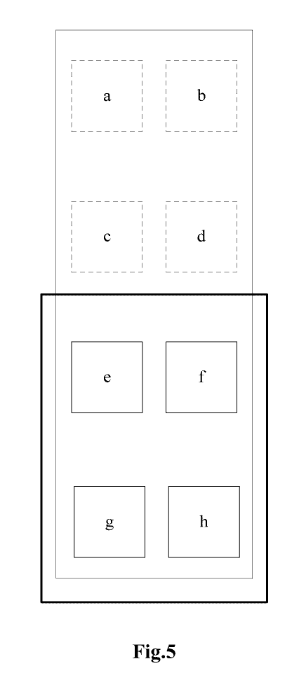

Referring to FIGS. 4-5, as an example, in FIG. 4, pictures “c” to “f” have been displayed on the screen. At this time, the user scrolls the screen downwardly, and pictures “g” and “h” not displayed currently become pictures to be displayed, which will be right to be displayed on the screen as the screen is scrolled. FIG. 5 is a schematic diagram of a state in which pictures “g” and “h” are finally displayed on the screen.

For another example, the preset operation may include a pinch operation, and the reading the picture right to be loaded to the screen area due to the preset operation may include reading the picture right to be loaded to the screen area due to an enlargement in a display range of page.

As for the pinch operation, when a current page is shrank by double fingers, the display range of the page is enlarged, such that more pictures are right to be loaded to the screen area. Such pictures right to be loaded to the screen area due to an enlargement in a display range of page can be pictures to be displayed.

For yet another example, the preset operation may include an operation of clicking a hyperlink, and the reading the picture right to be loaded to the screen area due to the preset operation may include reading a picture in a page corresponding to the hyperlink.

If the user clicks one hyperlink in a current page, a new page is to be loaded, and thus a new picture is to be loaded. Therefore, the picture in the page corresponding to the hyperlink can be a picture to be displayed.

As for what the specific animation corresponding to the picture is, there is no limitation in the present embodiment. In the present embodiment or some other embodiments of the present disclosure, the animation may be an animation by having the picture shown with a gradient effect.

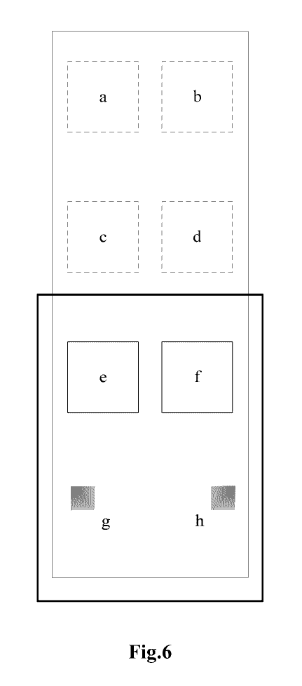

Referring to FIG. 6, as an example, after pictures “g” and “h” enter to the screen, an animation as shown in FIG. 6 can be displayed firstly, and then is changed into a form of whole pictures of the pictures “g” and “h” as shown in FIG. 5.

As an example, the having the picture shown with the gradient effect may include changing the picture from being fully transparent to being fully opaque during a preset duration.

For example, the present duration may be 500 ms.

For another example, the animation may further be an animation shown by expanding the picture from a center thereof in a box shape, or shown by expanding the picture in a form of shutter, or shown by expanding the picture in a form of clock hand rotation, and the like.

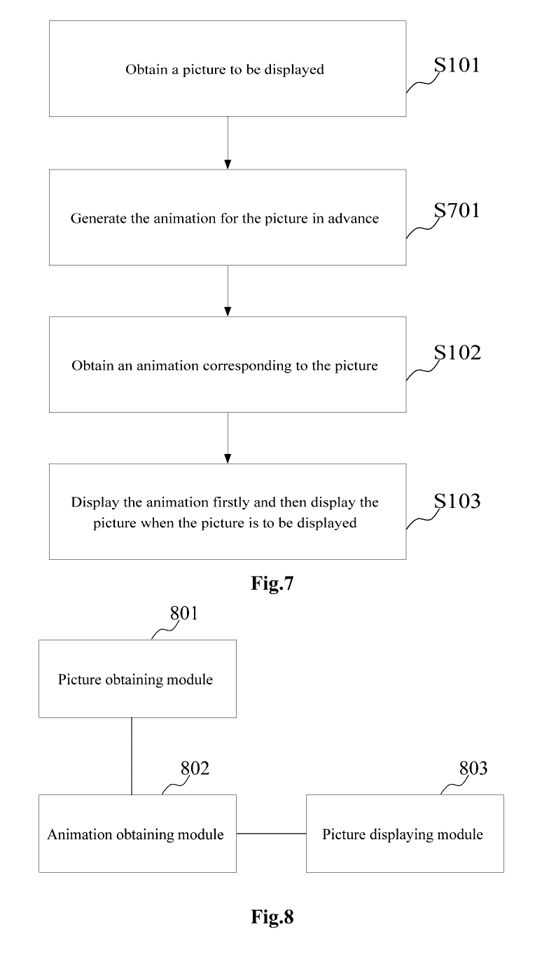

Furthermore, referring to FIG. 7, in the present embodiment or some other embodiments of the present disclosure, the method may further include the following step.

In step S701, the animation is generated for the picture in advance.

In the present embodiment, after a mobile phone obtains a picture to be displayed, an animation will be generated for the picture in advance before the picture is displayed on a screen. In some other embodiments of the present disclosure, the animation may not be generated by a mobile phone, but provided by a server for the picture, in other words, an animation corresponding to a picture will be downloaded at the same time when the picture is downloaded by a mobile phone from a server. As for how to obtain an animation corresponding to the picture, there is no limitation in the present embodiment.

In the present embodiment, when a picture in a page is to be displayed, instead of being displayed immediately, an animation is displayed firstly, for example, an animation by having the picture shown with a gradient effect is displayed firstly, and then the picture itself is displayed. Although it may take a little additional time to obtain and display the animation, the picture can be shown naturally during a transition from being absent to being present, rather than being popped out abruptly, which allows the user to feel a fluent display in the page, thereby improving user's experiences.

Embodiments of device of the present disclosure are described below, which may be applied to perform embodiments of the method of the present disclosure. As for details not disclosed in embodiments of device of the present disclosure, please refer to embodiments of method of the present disclosure.

FIG. 8 is a schematic diagram illustrating a device for displaying picture according to an exemplary embodiment. The device may be applied to a terminal device such as mobile phone, tablet computer and the like.

Referring to FIG. 8, the device may include: a picture obtaining module 801 for obtaining a picture to be displayed; an animation obtaining module 802 for obtaining an animation corresponding to the picture; and a picture displaying module 803 for displaying the animation firstly and then displaying the picture when the picture is to be displayed.

Referring to FIG. 9, in the present embodiment or some other embodiments of the present disclosure, the picture obtaining module 801 may include: an operation detecting submodule 8011 for determining whether a preset operation is detected; and a picture reading submodule 8012 for reading a picture right to be loaded to a screen area due to the preset operation when the preset operation is detected.

For example, the preset operation includes a scrolling operation toward a preset direction, and the picture reading submodule is configured to read the picture right to be loaded to the screen area in the scrolling direction.

For another example, the preset operation includes a pinch operation, and the picture reading submodule is configured to read the picture right to be loaded to the screen area due to an enlargement in a display range of page.

For yet another example, the preset operation includes an operation of clicking a hyperlink, and the picture reading submodule is configured to read a picture in a page corresponding to the hyperlink.

In the present embodiment or some other embodiments of the present disclosure, the animation is an animation by having the picture shown with a gradient effect.

In the present embodiment or some other embodiments of the present disclosure, the having the picture shown with the gradient effect includes: changing the picture from being fully transparent to being fully opaque during a preset duration.

For another example, the animation is an animation shown by expanding the picture from a center thereof in a box shape, or shown by expanding the picture in a form of shutter, or shown by expanding the picture in a form of clock hand rotation and the like. As for what the animation corresponding to the picture is, there is no limitation in the present embodiment.

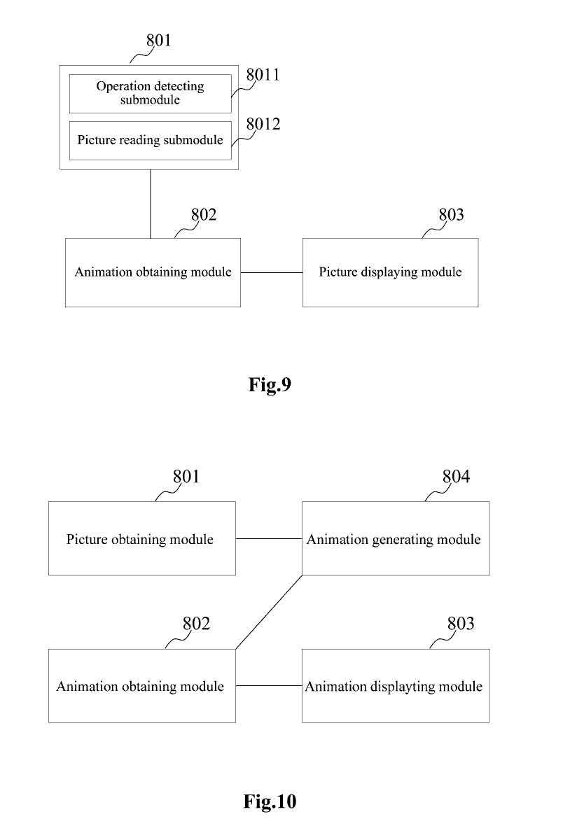

Referring to FIG. 10, in the present embodiment or some other embodiments of the present disclosure, the device may further include an animation generating module 804 for generating the animation for the picture in advance.

In the present embodiment, when a picture in a page is to be displayed, instead of being displayed immediately, an animation is displayed firstly, for example, an animation by having the picture shown with a gradient effect is displayed firstly, and then the picture itself is displayed. Although it may take a little additional time to obtain and display the animation, the picture can be shown naturally during a transition from being absent to being present, rather than being popped out abruptly, which allows the user to feel a fluent display in the page, thereby improving user's experiences.

In regard to the device mentioned in the above embodiment, the specific method of operating the respective module has been described in the embodiments of the corresponding methods, and thus detailed descriptions thereof are omitted herein.

The embodiments of the present disclosure further provide a non-volatile computer storage medium stored with computer executable instructions which are used to perform any of the methods for displaying picture in the above embodiments.

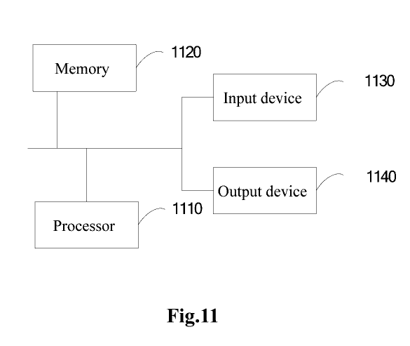

FIG. 11 is a schematic structure diagram of an electronic device for performing a method for displaying picture according to an embodiment. As shown in FIG. 11, the device includes one or more processors 1110 and a memory 1120, and FIG. 11 illustrates one processor 1110 as an example.

The device for performing a method for displaying picture may further include an input device 1130 and an output device 1140.

The processor 1110, memory 1120, input device 1130 and output device 1140 may be connected with each other through bus or other forms of connections. FIG. 11 illustrates bus connection as an example.

As a non-volatile computer readable storage medium, the memory 1120 may be configured to store non-volatile software program, non-volatile computer executable program and modules, such as program instructions/modules corresponding to the method for displaying picture according to the embodiments of the present disclosure (for example, the picture obtaining module 801, animation obtaining module 802 and picture displaying module 803, as illustrated in FIG. 8). By executing the non-volatile software program, instructions and modules stored in the memory 1120, the processor 1110 may perform various functional applications of a server and data processing, that is, the method for displaying picture according to the above embodiments.

The memory 1120 may include a program storage area and a data storage area, the program storage area may be stored with an operating system and applications which are needed by at least one functions, and the data storage area may be stored with data which is created according to use of the device for displaying picture. Further, the memory 1120 may include a high-speed random access memory, and may further include non-volatile memory, such as at least one of disk memory device, flash memory device or other types of non-volatile solid state memory device. In some embodiments, optionally, the memory 1120 may include memory provided remotely from the processor 1110, and such memory may be connected with the device for displaying picture through network connections. The examples of the network connections may include but not limited to internet, intranet, LAN (Local Area Network), mobile communication network or combinations thereof.

The input device 1130 may receive inputted digital or character information, and generate key signal input related to the user settings and functional control of the device for displaying picture. The output device 1140 may include a display device such as a display screen.

The above one or more modules may be stored in the memory 1120, when these modules are executed by the one or more processor 1110, the method for displaying picture according to any one of the above mentioned embodiments may be performed.

The above product may perform the methods provided in the embodiments of the present disclosure, include functional modules corresponding to these methods and advantageous effects. Further technical details which are not described in detail in the present embodiment may refer to the methods provided according to embodiments of the disclosure.

The electronic device in embodiments of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned embodiments for the device are merely illustrative, wherein the unit illustrated as a separated component may be or may not be physically separated, the component illustrated as a unit may be or may not be a physical unit, in other words, may be either disposed in a same place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to perform the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for displaying picture, comprising at an electronic device:
obtaining a picture to be displayed;
obtaining an animation corresponding to the picture; and
displaying the animation firstly and then displaying the picture, when the picture is to be displayed.

2. The method according to claim 1, wherein, the obtaining the picture to be displayed comprises:
determining whether a preset operation is detected; and
reading a picture right to be loaded to a screen area due to the preset operation if the preset operation is detected.

3. The method according to claim 2, wherein, the preset operation comprises a scrolling operation toward a preset direction, and
the reading the picture right to be loaded to the screen area due to the preset operation comprises:
reading the picture right to be loaded to the screen area in the scrolling direction.

4. The method according to claim 2, wherein, the preset operation comprises a pinch operation, and
the reading the picture right to be loaded to the screen area due to the preset operation comprises:
reading the picture right to be loaded to the screen area due to an enlargement in a display range of page.

5. The method according to claim 2, wherein, the preset operation comprises an operation of clicking a hyperlink, and
the reading the picture right to be loaded to the screen area due to the preset operation comprises:
reading a picture in a page corresponding to the hyperlink.

6. The method according to claim 1, wherein, the animation is an animation by having the picture shown with a gradient effect.

7. The method according to claim 6, wherein, the having the picture shown with the gradient effect comprises:
changing the picture from being fully transparent to being fully opaque during a preset duration.

8. The method according to claim 1, further comprising:
generating the animation for the picture in advance.

9. A non-volatile computer-readable storage medium, which is stored with computer executable instructions that, when executed by an electronic device, cause the electronic device to:
obtain a picture to be displayed;
obtain an animation corresponding to the picture; and
display the animation firstly and then display the picture, when the picture is to be displayed.

10. The non-volatile computer-readable storage medium according to claim 9, wherein, the obtaining the picture to be displayed comprises:
determining whether a preset operation is detected; and
reading a picture right to be loaded to a screen area due to the preset operation if the preset operation is detected.

11. The non-volatile computer-readable storage medium according to claim 10, wherein, the preset operation comprises a scrolling operation toward a preset direction, and
the reading the picture right to be loaded to the screen area due to the preset operation comprises:
reading the picture right to be loaded to the screen area in the scrolling direction.

12. The non-volatile computer-readable storage medium according to claim 10, wherein, the preset operation comprises a pinch operation, and
the reading the picture right to be loaded to the screen area due to the preset operation comprises:
reading the picture right to be loaded to the screen area due to an enlargement in a display range of page.

13. The non-volatile computer-readable storage medium according to claim 10, wherein, the preset operation comprises an operation of clicking a hyperlink, and
the reading the picture right to be loaded to the screen area due to the preset operation comprises:
reading a picture in a page corresponding to the hyperlink.

14. The non-volatile computer-readable storage medium according to claim 9, wherein, the animation is an animation by having the picture shown with a gradient effect.

15. An electronic device, comprising:
at least one processor; and
a memory, communicably connected with the at least one processor and storing instructions executable by the at least one processor,
wherein execution of the instructions by the at least one processor causes the at least one processor to:
obtain a picture to be displayed;
obtain an animation corresponding to the picture; and
display the animation firstly and then display the picture, when the picture is to be displayed.

16. The electronic device according to claim 15, wherein, the obtaining the picture to be displayed comprises:
determining whether a preset operation is detected; and
reading a picture right to be loaded to a screen area due to the preset operation if the preset operation is detected.

17. The electronic device according to claim 16, wherein, the preset operation comprises a scrolling operation toward a preset direction, and
the reading the picture right to be loaded to the screen area due to the preset operation comprises:
reading the picture right to be loaded to the screen area in the scrolling direction.

18. The electronic device according to claim 16, wherein, the preset operation comprises a pinch operation, and
the reading the picture right to be loaded to the screen area due to the preset operation comprises:
reading the picture right to be loaded to the screen area due to an enlargement in a display range of page.

19. The electronic device according to claim 16, wherein, the preset operation comprises an operation of clicking a hyperlink, and
the reading the picture right to be loaded to the screen area due to the preset operation comprises:
reading a picture in a page corresponding to the hyperlink.

20. The electronic device according to claim 15, wherein, the animation is an animation by having the picture shown with a gradient effect.
